(19) United States
(12) Patent Application Publication
(10) Pub. No.: US 2024/0217773 A1
(43) Pub. Date: Jul. 4, 2024

(54) ELEVATOR OPERATING DEVICE

(71) Applicant: Otis Elevator Company, Farmington, CT (US)

(72) Inventor: Xiaobin Tang, Tianjin (CN)

(21) Appl. No.: 18/449,466

(22) Filed: Aug. 14, 2023

(30) Foreign Application Priority Data
Dec. 28, 2022 (CN) 202211695675.3

(51) Int. Cl. B66B 1/34; B66B 1/46; B66B 1/52

(52) U.S. Cl. CPC B66B 1/3461; B66B 1/3453; B66B 1/468; B66B 1/52; B66B 2201/463

(57) ABSTRACT

An elevator operation device or car operation panel for users to input elevator operation commands. An elevator operation device includes an operation panel including a plurality of first button units, each of the plurality of first button units being configured to receive a corresponding first elevator operation command and to generate a first message indicating receipt of the first elevator operation command; a control unit configured to generate an elevator operation request based on the first message and to send the elevator operation request to a remote control device, wherein the plurality of first button units are in communication with the control unit via a serial bus.

### FOREIGN PRIORITY

This application claims priority to Chinese Patent Application No. 202211695675.3, filed Dec. 28, 2022, and all the benefits accruing therefrom under 35 U.S.C. § 119, the contents of which in its entirety are herein incorporated by reference.

### TECHNICAL FIELD

The present application relates to elevator technology, and in particular to an elevator operation device or car operation panel for users to input elevator operation commands.

### BACKGROUND

An elevator operation device may be arranged inside a car, and users may manipulate operations of the car through command switches, buttons, handles, etc. on it. For the consideration of manufacturing, installation and maintenance convenience, the internal structure of the elevator operation device should be as simple and compact as possible.

### SUMMARY

According to an aspect of the present application, there is provided an elevator operation device, comprising: an operation panel comprising a plurality of first button units, each of the plurality of first button units being configured to receive a corresponding first elevator operation command and to generate a first message indicating receipt of the first elevator operation command; a control unit configured to generate an elevator operation request based on the first message and to send the elevator operation request to a remote control device, wherein the plurality of first button units are in communication with the control unit via a serial bus.

Optionally, in the elevator operation device described above, each of the plurality of first button units comprises: a first button; a first communication module connected to the serial bus, configured to: generate, in response to an event of the first button being pressed or of an event of an object being present in the vicinity of the first button, the first message indicating the receipt of the corresponding first elevator operation command, wherein the first message comprises a first button identification associated with the first button; send the first message to the control unit.

Optionally, in the elevator operation device described above, the elevator operation request comprises the first message and a device identification associated with the elevator operation device.

Optionally, in the elevator operation device described above, the elevator operation request comprises a first elevator operation command corresponding to the first button identification and a device identification associated with the elevator operation device.

In addition to one or more of the above features, in the elevator operation device described above, the remote control device is an elevator control cabinet and the control unit communicates with the remote control device by wired or wireless means.

In addition to one or more of the above features, in the elevator operation device described above, the serial bus is based on one of the following protocols: 1-wire bus, single bus protocol, UNI/O bus protocol, and I2C bus protocol.

In addition to one or more of the above features, in the elevator operation device described above, the serial bus comprises a first serial bus and a second serial bus, the control unit being configured to communicate with the plurality of first button units via the second serial bus in the event of a communication failure with the plurality of first button units via the first serial bus.

In addition to one or more of the above features, in the elevator operation device described above, the operation panel further comprises at least one second button unit, the second button unit being configured to receive a corresponding second elevator operation command and to generate a second message indicating receipt of the second elevator operation command, the control unit being configured to generate the elevator operation request based on the second message and to send the elevator operation request to the remote control device, wherein the second button unit communicates with the control unit in a point-to-point manner.

Optionally, in the elevator operation device described above, the second button unit comprises: a second button; a second communication module connected with the control unit via a separate line, configured to: generate, in response to an event of the second button being pressed or of an event of an object being present in the vicinity of the second button, the second message indicating the receipt of the corresponding second elevator operation command, wherein the second message comprises a second button identification associated with the second button; send the second message to the control unit.

Optionally, in the elevator operation device described above, the elevator operation request comprises the second message and a device identification associated with the elevator operation device.

Optionally, in the elevator operation device described above, the elevator operation request comprises a second elevator operation command corresponding to the second button identification and a device identification associated with the elevator operation device.

Optionally, in the elevator operation device described above, the first button is a floor selection button, an up button and a down button, and the second button is an intercom button and an alarm button.

### DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1 is a schematic diagram of an elevator operation device in accordance with some embodiments of the present application.

FIG. 2 is a schematic diagram of a button unit in accordance with some other embodiments of the present application.

FIG. 3 is a schematic diagram of an elevator operation device in accordance with some other embodiments of the present application.

FIG. 4 is a schematic diagram of a button unit in accordance with some other embodiments of the present application.

FIG. 5 is a schematic diagram of an elevator operation device in accordance with some other embodiments of the present application.

### DETAILED DESCRIPTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

An elevator operation device usually comprises several buttons (e.g. floor selection button, up button, down button, intercom button, alarm button, etc.) and a control unit. Each button corresponds to a different elevator operation command. For example, the press of the floor selection button indicates an operation command to stop a car to a floor corresponding to the button, the press of the up button (down button) indicates an operation command to move the car up (down), the press of the intercom button indicates an operation command to activate an intercom equipment, and the press of the alarm button indicates an operation command to send alarm messages. In response to the event that the button is pressed, a message indicating the corresponding elevator operation command is sent to the control unit, which then generates a corresponding elevator operation request based on this message and sends the elevator operation request to an external device (such as an elevator control cabinet). In some embodiments of the present application, all or some of the plurality of button units (e.g., the floor selection button, the up button, and the down button) communicate with the control unit via a serial bus. Compared to the case where each button unit communicates with the control unit in a point-to-point manner, the serial method can significantly reduce the number of wires used to connect the button units with the control unit, which is advantageous for optimizing the structure of the elevator operation device.

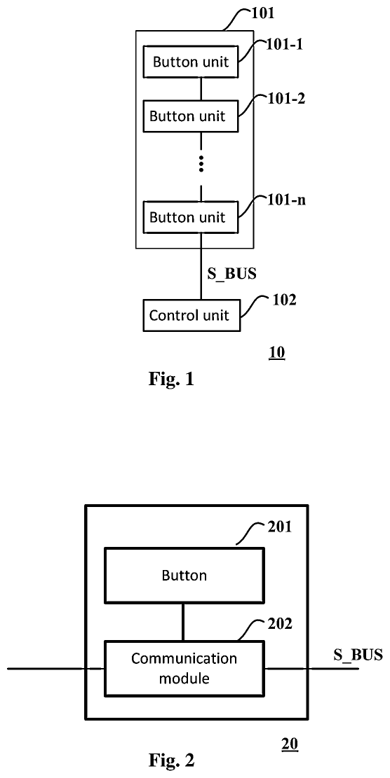

FIG. 1 is a schematic diagram of an elevator operation device in accordance with some embodiments of the present application.

An elevator operation device 10 shown in FIG. 1 includes an operation panel 101 and a control unit 102. Referring to FIG. 1, the operation panel 101 comprises a plurality of button units 101-1 to 101-n that communicate with the control unit 102 via a serial bus S_BUS. Various communication protocols may be utilized to achieve serial communication between the button units and the control unit, such as, but not limited to, 1-wire bus, single bus protocol, UNI/O bus protocol, and I²C bus protocol, etc.

In the elevator operation device shown in FIG. 1, each of the button units 101-1 to 101-n is configured to receive a corresponding elevator operation command and to generate a message indicating receipt of the elevator operation command.

FIG. 2 is a schematic diagram of a button unit in accordance with some other embodiments of the present application. The button units 101-1 to 101-n shown in FIG. 1 may adopt the structure shown in FIG. 2.

Referring to FIG. 2, a button unit 20 as shown therein comprises a button 201 and a communication module 202 that is connected to the serial bus S_BUS. As described above, each button may correspond to a different elevator operation command. As an example, suppose that the button 201 corresponds to the operation command to make the car stop at a desired floor. In some embodiments, when the button is pressed (e.g., when the button is a mechanical button) or when an object is present in the vicinity of the button (e.g., when the button is a capacitive sensing button), a circuit loop connecting the button 201 with the communication module 202 will be caused to close, thereby generating a trigger signal. The communication module 202 may, for example, be implemented using an integrated circuit chip. In response to the trigger signal, the communication module 202 generates a message indicating receipt of the corresponding elevator operation command and sends the message to the control unit 102, wherein the message may comprise a button identification ID_B associated with the button 201. It should be noted that various identifications that can distinguish the button 201 from other buttons are available for the button identification ID_B, such as a bus address of the communication module 202.

Continuing with FIG. 1, the control unit 102 is configured to generate an elevator operation request R based on the message and send the elevator operation request R to a remote control device, such as an elevator control cabinet. Communication between the control unit 102 and the remote control device may be wired or wireless.

In some examples, the elevator operation request R may comprise the message and a device identification ID_COP associated with the elevator operation device 10. For example, the elevator operation request R takes the form of a signal frame, the message from the communication module 202 is packaged within the signal frame and the device identification ID_COP is filled into the frame header to generate the elevator operation request R.

In other examples, the elevator operation request R comprises the elevator operation command corresponding to the button identification ID_B and the device identification ID_COP associated with the elevator operation device. In the case where the elevator operation request R takes the form of the signal frame, the button identification ID_B in the message is extracted and then filled into the corresponding field in the signal frame and the device identification ID_COP is filled into the frame header, thereby generating the elevator operation request R.

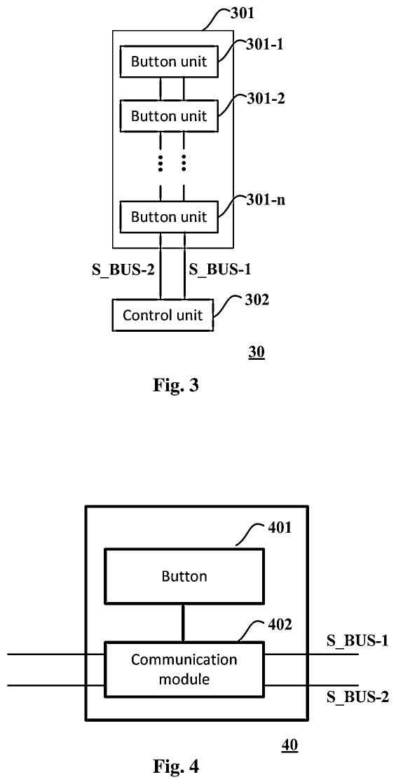

FIG. 3 is a schematic diagram of an elevator operation device in accordance with some other embodiments of the present application.

An elevator operation device 30 shown in FIG. 3 includes an operation panel 301 and a control unit 302. Referring to FIG. 3, the operation panel 301 comprises a plurality of button units 301-1 to 301-n. Unlike the embodiment shown in FIG. 1, in the elevator operation device shown in FIG. 3, the plurality of button units 301-1 to 301-n may communicate with the control unit 302 via a serial bus S_BUS−1 or S_BUS-2. Similarly, available serial communication protocols include, for example, but are not limited to, 1-wire bus, single bus protocol, UNI/O bus protocol, and I2C bus protocol, etc.

In the elevator operation device shown in FIG. 3, each of the button units 301-1 to 301-n is configured to receive a corresponding elevator operation command and generate a message indicating receipt of the elevator operation command. Similarly, the button units 301-1 to 301-n may adopt the structure shown in FIG. 4. In particular, each button unit 40 may comprise a button 401 and a communication module 402 connected to the serial buses S_BUS−1 and S_BUS−2. When the button 401 is pressed or when an object is present in the vicinity of the button 401, a circuit loop connecting the button 401 with the communication module 402 closes to generate a trigger signal, and the communication module 402 generates a message indicating the receipt of the corresponding elevator operation command and sends the message containing the button identification ID_B to the control unit 302 responding to the trigger signal.

The control unit 302 is configured to generate an elevator operation request R based on the message and send the elevator operation request R to the remote control device by wired or wireless means. Similar to the embodiment shown in FIG. 1, the elevator operation request R may contain the message and the device identification ID_COP associated with the elevator operation device 10, or may contain the elevator operation command corresponding to the button identification ID_B and the device identification ID_COP associated with the elevator operation device.

Continuing with FIG. 3, exemplarily, it is assumed that, by default, the button units 301-1 to 301-n communicate with the control unit 302 via the serial bus S_BUS−1. The control unit 302 may be configured to switch to communicating with the button units 301-1 to 301-n via the serial bus S_BUS−2 in the event of a failure in communication with the button units 301-1 to 301-n via the serial bus S_BUS−1. Exemplarily, the button units 301-1 to 301-n may be set to periodically send a heartbeat signal to the control unit 302 via the serial bus S_BUS−1. If the control unit 302 does not receive the heartbeat signal, it sends a wake-up signal to the button units 301-1 to 301-n via the serial bus S_BUS−2, thereby instructing the button units 301-1 to 301-n to communicate with the control unit 302 via the serial bus S_BUS−2.

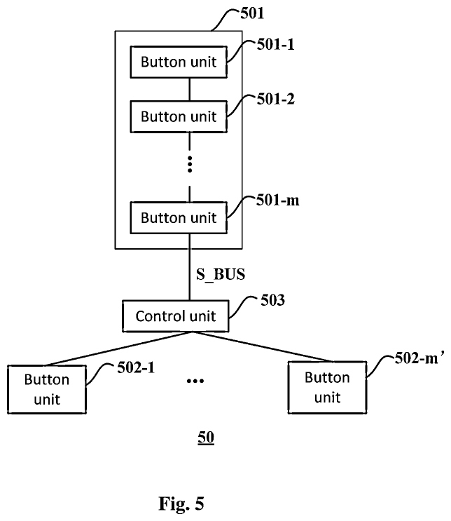

FIG. 5 is a schematic diagram of an elevator operation device in accordance with some other embodiments of the present application.

An elevator operation device 50 shown in FIG. 5 includes an operation panel 501 and a control unit 503. Referring to FIG. 5, the operation panel 501 includes button units 501-1 to 501-m and button units 502-1 to 502-m′. Unlike the embodiments shown in FIGS. 1 and 3, in the elevator operation device shown in FIG. 5, the button units 501-1 to 501-m communicate with the control unit 503 via a serial bus S_BUS, while each of the button units 502-1 to 502-m′ communicates with the control unit 503 in a point-to-point manner. Similarly, available serial communication protocols include, for example, but are not limited to, 1-wire bus, single bus protocol, UNI/O bus protocol, and I2C bus protocol, etc.

In the elevator operation device shown in FIG. 5, each of the button units 501-1 to 501-m and 502-1 to 502-m′ is configured to receive a corresponding elevator operation command and generate a message indicating receipt of the elevator operation command. Similarly, the button units 501-1 to 501-m may adopt the structure shown in FIG. 2 or 4. In particular, each of the button units 501-1 to 501-m may comprise a button and a communication module that is connected to the serial bus. In addition, each of the button units 502-1 to 502-m′ may comprise a button and a communication module that communicates with a control unit 403 in a point-to-point manner. In the button units 501-1 to 501-m and button units 502-1 to 502-m′, when the button is pressed or when an object is present in the vicinity of the button, a circuit loop connecting the button with the communication module closes to generate a trigger signal, and the communication module generates a message indicating the receipt of the corresponding elevator operation command and sends the message containing the button identification ID_B to the control unit 403 responding to the trigger signal.

In an exemplary embodiment, the button units 501-1 to 501-m comprise floor selection button, up button, and down button, and the button units 502-1 to 502-m′ comprise intercom buttons and alarm buttons.

The control unit 403 is configured to generate an elevator operation request R based on the message and send the elevator operation request R wirelessly or wired to the remote control device. Similar to the embodiment shown in FIGS. 1 and 3, the elevator operation request R may comprise the message and the device identification ID_COP associated with the elevator operation device 10, or may comprise the elevator operation command corresponding to the button identification ID_B and the device identification ID_COP associated with the elevator operation device.

In the embodiments shown in FIGS. 1-5, when the communication module or the control unit is commonly implemented with an integrated circuit chip, other functions can be provided with the aid of the chip's greater processing power. For example, the communication module may be configured to keep an indicator light of the button in a flashing state when the button reaches its service life or requires maintenance, to perform jitter reduction of the button, and to identify the operation command based on the way the button is pressed (e.g., a long press of the button for 5 seconds or three consecutive short presses to activate a secure floor).

Those skilled in the art will appreciate that the various illustrative logical blocks, control units, modules, circuits, and algorithm steps described herein may be implemented as electronic hardware, computer software, or combinations of both.

To demonstrate this interchangeability between hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. An elevator operation device, comprising:
an operation panel comprising a plurality of first button units, each of the plurality of first button units being configured to receive a corresponding first elevator operation command and to generate a first message indicating receipt of the first elevator operation command;
a control unit configured to generate an elevator operation request based on the first message and to send the elevator operation request to a remote control device,
wherein the plurality of first button units are in communication with the control unit via a serial bus.

2. The elevator operation device of claim 1, wherein each of the plurality of first button units comprises:
a first button;
a first communication module connected to the serial bus, configured to:
generate, in response to an event of the first button being pressed or of an event of an object being present in the vicinity of the first button, the first message indicating the receipt of the corresponding first elevator operation command, wherein the first message comprises a first button identification associated with the first button;
send the first message to the control unit.

3. The elevator operation device of claim 2, wherein the elevator operation request comprises the first message and a device identification associated with the elevator operation device.

4. The elevator operation device of claim 2, wherein the elevator operation request comprises a first elevator operation command corresponding to the first button identification and a device identification associated with the elevator operation device.

5. The elevator operation device of claim 1, wherein the remote control device is an elevator control cabinet and the control unit communicates with the remote control device by wired or wireless means.

6. The elevator operation device of claim 1, wherein the serial bus is based on one of the following protocols: 1-wire bus, single bus protocol, UNI/O bus protocol, and I²C bus protocol.

7. The elevator operation device of claim 1, wherein the serial bus comprises a first serial bus and a second serial bus, the control unit being configured to communicate with the plurality of first button units via the second serial bus in the event of a communication failure with the plurality of first button units via the first serial bus.

8. The elevator operation device of claim 1,
wherein the operation panel further comprises at least one second button unit, the second button unit being configured to receive a corresponding second elevator operation command and to generate a second message indicating receipt of the second elevator operation command, the control unit being configured to generate the elevator operation request based on the second message and to send the elevator operation request to the remote control device,
wherein the second button unit communicates with the control unit in a point-to-point manner.

9. The elevator operation device of claim 8, wherein the second button unit comprises:
a second button;
a second communication module connected with the control unit via a separate line, configured to:
generate, in response to an event of the second button being pressed or of an event of an object being present in the vicinity of the second button, the second message indicating the receipt of the corresponding second elevator operation command, wherein the second message comprises a second button identification associated with the second button;
send the second message to the control unit.

10. The elevator operation device of claim 9, wherein the elevator operation request comprises the second message and a device identification associated with the elevator operation device.

11. The elevator operation device of claim 9, wherein the elevator operation request comprises a second elevator operation command corresponding to the second button identification and a device identification associated with the elevator operation device.

12. The elevator operation device of claim 9, wherein the first button is a floor selection button, an up button and a down button, and the second button is an intercom button and an alarm button.
